(19) United States
(12) Patent Application Publication
(10) Pub. No.: US 2009/0100123 A1
(43) Pub. Date: Apr. 16, 2009

(54) DATA COMMUNICATION APPARATUS, CONTROL METHOD FOR DATA COMMUNICATION APPARATUS, AND STORAGE MEDIUM

(75) Inventor: Tomoya Sato, Kawasaki-shi (JP)

Correspondence Address: ROSSI, KIMMS & McDOWELL LLP., 20609 Gordon Park Square, Suite 150, Ashburn, VA, 20147, US

(73) Assignee: CANON KABUSHIKI KAISHA, Tokyo (JP)

(21) Appl. No.: 12/249,558

(22) Filed: Oct. 10, 2008

(30) Foreign Application Priority Data
Oct. 15, 2007 (JP) 2007-268009

(51) Int. Cl. G06F 15/16

(52) U.S. Cl. 709/201

(57) ABSTRACT

A data communication system which enables a user to easily receive desired transfer data by an apparatus to which the user has logged in, thereby making it possible to improve user convenience. A server apparatus has a function of transferring data received via a public telephone line or a network to a client apparatus. The server apparatus stores transfer condition for transferring received data. Upon reception of a login notification from the client apparatus, the server apparatus determines whether or not there is transfer data to be transferred to a user who has logged into the client apparatus, based on the transfer condition. If there is the transfer data for the user, the server apparatus transfers the transfer data to the user.

### BACKGROUND OF THE INVENTION

1. Field of the Invention

The present invention relates to a data communication apparatus having a function of transferring data received via a public telephone line or a network to another apparatus, a control method for the data communication apparatus, and a storage medium storing a program for implementing the control method.

2. Description of the Related Art

Conventionally, there has been known an image forming apparatus (digital multifunction apparatus) having a function of transmitting and receiving data. In an image forming apparatus of this kind, a transfer function is realized for transferring received facsimile data and IFAX (Internet Fax) data to another image forming apparatus, a file server, or the like via a network or a public telephone line.

The transfer function described above is configured such that received data is transferred to a specified transfer destination if the data satisfies transfer conditions set in advance for the image forming apparatus. In the case of the facsimile data, for example, there are set conditions concerning telephone numbers of transmission sources, F codes, passwords, and like other items. In the case of the IFAX data, there are set conditions concerning destinations, senders, subject names, and like other items.

A user can register transfer conditions on an item-by-item basis by specifying complete matching, partial matching, non-matching, etc. (see e.g. Japanese Patent Laid-Open Publication No. 2001-358876). This transfer function enables the user of an image forming apparatus to automatically transfer data received at the image forming apparatus to an image forming apparatus which is closest to his seat, for example.

Recently, more and more offices come to use a free address system in which staff members work at desired ones of shared desks without being bound to respective dedicated desks of their own. In such an environment, it has been a common practice to work at different floors in different offices day by day. Further, it is increasingly demanded to enable a user to receive transfer data by a different image forming apparatus than the user usually uses, at a destination of a business trip.

However, in the transfer function of the conventional image forming apparatus, it is required to determine in advance an image forming apparatus as a destination to which received data is to be transferred when the data satisfies the transfer conditions. Although work is performed at different desks day by day by virtue of the free address system, an image forming apparatus to which transfer data is to be transferred is determined in advance.

This makes it necessary for the user to go to the image forming apparatus set in advance to take data transferred thereto whenever the transfer data is received, or change the transfer destination as a transfer condition to an image forming apparatus convenient for the user, which is troublesome for the user.

### SUMMARY OF THE INVENTION

The present invention provides a data communication apparatus, a control method for the data communication apparatus, and a storage medium storing a program for implementing the control method, which enable a user to easily receive desired transfer data by an apparatus to which the user has logged in, thereby making it possible to improve user convenience.

In a first aspect of the present invention, a data communication apparatus having a function of transferring data received via a public telephone line or a network to another apparatus, comprising a storage unit configured to store transfer condition set based on information contained in the received data or information received together with the received data, a login notification-receiving unit configured to receive a login notification from the other apparatus, a determination unit configured to determine whether there is transfer data that satisfies the transfer condition stored in said storage unit and is to be transferred to a user associated with the login notification received by said login notification-receiving unit, and a transfer unit configured to transfer transfer data to the other apparatus that has transmitted the login notification received by said login notification-receiving unit, when said determination unit determines that there is the transfer data.

In a second aspect of the present invention, there is provided a method of controlling a data communication apparatus having a function of transferring data received via a public telephone line or a network to another apparatus, comprising storing transfer conditions set based on information contained in the received data or information received together with the received data, receiving a login notification from the other apparatus, determining whether there is transfer data that satisfies the stored transfer conditions and is to be transferred to a user associated with the received login notification, and transferring transfer data to the other apparatus that has transmitted the received login notification, when it is determined that there is the transfer data.

In a third aspect of the present invention, a storage medium storing, in a computer-readable manner, a program for causing a computer to execute a method of controlling a data communication apparatus having a function of transferring data received via a public telephone line or a network to another apparatus, wherein the method comprises storing transfer conditions set based on information contained in the received data or information received together with the received data, receiving a login notification from the other apparatus, determining whether there is transfer data that satisfies the stored transfer conditions and is to be transferred to a user associated with the received login notification, and transferring transfer data to the other apparatus that has transmitted the received login notification, when it is determined that there is the transfer data.

According to the present invention, it is possible to easily receive desired transfer data by an apparatus to which a user has logged in, thereby making it possible to improve user convenience.

The features and advantages of the invention will become more apparent from the following detailed description taken in conjunction with the accompanying drawings.

### BRIEF DESCRIPTION OF THE DRAWINGS

FIG. 1 is a view of the basic configuration of a data communication system according to an embodiment of the present invention.

FIG. 2 is a schematic block diagram of hardware configuration of an image forming apparatus appearing in FIG. 1.

FIG. 3 is a functional block diagram of pieces of software that operate on a controller unit appearing in FIG. 2.

FIG. 4 is a view showing an example of a transfer condition-setting screen displayed on an operating section using a UI function section appearing in FIG. 3.

FIG. 5 is a view showing an example of a transfer condition-setting screen displayed when an IFAX is selected as receiving means by depressing a receiving means-setting pull-down menu button appearing in FIG. 4.

FIG. 6 is a view showing an example of a transfer destination-setting screen displayed when an area 410 in FIG. 4 is depressed.

FIG. 7 is a view showing an example of a transfer document deleting condition-setting screen displayed when a deleting condition-setting button appearing in FIG. 4 is depressed.

FIG. 8 is a flowchart of a reception/transfer process executed by a facsimile server application appearing in FIG. 3.

FIG. 9 is a schematic view of data stored in a association with a user in a step S805 in FIG. 8.

FIG. 10 is a flowchart of a transfer data-receiving process executed by a facsimile client application appearing in FIG. 3.

FIG. 11 is a flowchart of a login notification-receiving process performed when the facsimile server application appearing in FIG. 3 receives a login notification from the facsimile client application appearing in FIG. 3.

### DETAILED DESCRIPTION OF THE EMBODIMENTS

The present invention will now be described in detail below with reference to the accompanying drawings showing embodiments thereof.

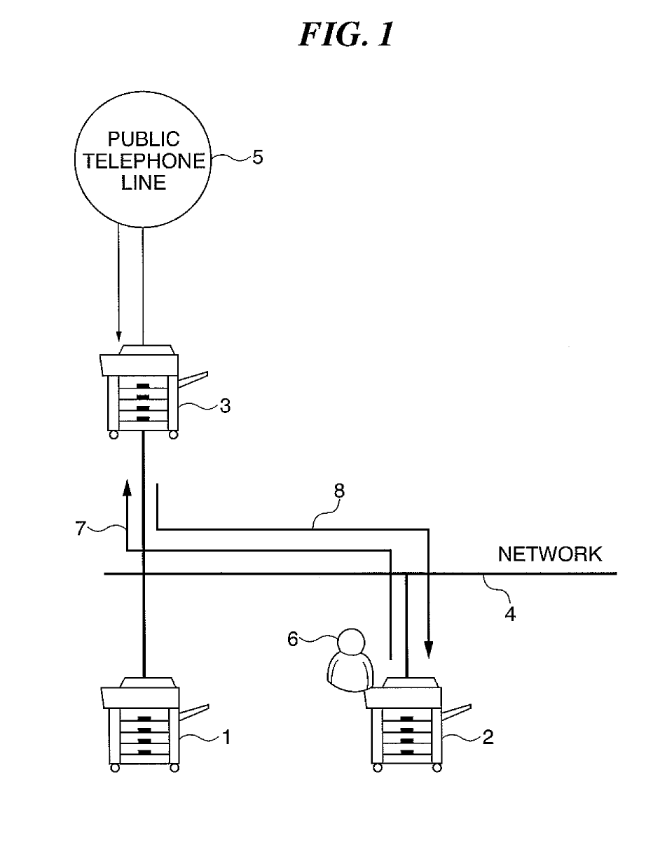

FIG. 1 is a view of the basic configuration of a data communication system according to an embodiment of the present invention.

Referring to FIG. 1, the data communication system is constructed by connecting image forming apparatuses 1 to 3 by a network 4. The network 4 is a LAN (Local Area Network) implemented e.g. by Ethernet (registered trademark). Of course, devices other than the image forming apparatuses may be connected via the network 4, and there is no need to connect all the image forming apparatuses 1 to 3.

The image forming apparatuses 1 and 2 are client apparatuses which are not directly connected to a public telephone line 5, and transmit and receive facsimile data via the image forming apparatus 3 functioning as a facsimile server.

The image forming apparatus 3 includes a facsimile board, and is directly externally connected to the public telephone line 5 such that it is capable of performing facsimile communication via the public telephone line 5 according to procedures specified e.g. in the recommendation T.30 of the ITU-T (International Telecommunication Union-Telecommunication Standardization Sector). Further, the image forming apparatus 3 is a server apparatus which is capable of transmitting image data to the image forming apparatuses 1 and 2 via the public telephone line 5 by facsimile when the image forming apparatuses 1 and 2 requests the image data, and transferring facsimile data received via the public telephone line 5 to the image forming apparatuses 1 and 2.

It should be noted that although the respective image forming apparatuses 1 to 3 can be used as client apparatuses (apparatuses which receive transfer data) and server apparatuses (apparatuses which transfer the transfer data), the present embodiment will be described assuming that the image forming apparatuses 1 and 2 are client apparatuses, and the image forming apparatus 3 is a server apparatus.

The server apparatus 3 includes a storage unit that stores transfer conditions set based on information contained in the received data or information received together with the received data, and a login notification-receiving unit that receives a login notification from the client apparatus 1 or 2.

Further, the server apparatus 3 includes a determination unit that determines whether there is transfer data that satisfies the transfer conditions stored in the storage unit, and is to be transferred to a user associated with the login notification received by the login notification-receiving unit.

Further, the server apparatus 3 includes a transfer unit that is operable when the determination unit determines that there is transfer data, to transfer the transfer data to the client apparatus 1 or 2 that has transmitted the login notification received by the login notification-receiving unit.

Further, the server apparatus 3 includes a deleting condition-determining unit that determines whether or not there are satisfied conditions for deleting the transfer data that has already been transferred by the transfer unit, and a data-deleting unit that deletes transfer data transferred by the transfer unit when the deleting condition-determining unit determines that the transfer data satisfies the deleting conditions.

Hereinafter, the server apparatus 3 will be described in detail.

The user 6 of this system logs into one of the image forming apparatuses 1 to 3 through user authentication to use the image forming apparatus. When the user 6 logs into the client apparatus 1 or 2, the client apparatus transmits a login notification to the sever apparatus 3 (see an arrow 7 in FIG. 1).

The server apparatus 3 has functions of determining whether or not there is stored transfer data to be transferred to the user 6 who has logged into the client apparatus, and transferring the transfer data to the apparatus 1 or 2 to which the user has logged in, if the transfer data is stored (see an arrow 8 in FIG. 1). Details of these operations will be described hereinafter.

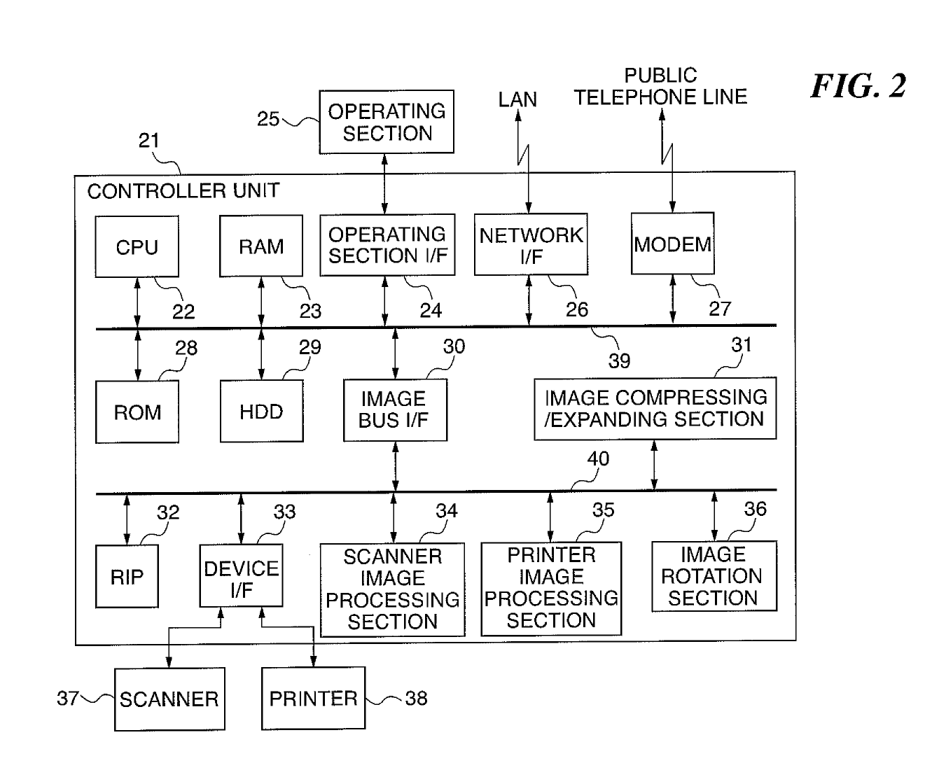

FIG. 2 is a schematic block diagram of hardware configuration of an image forming apparatus appearing in FIG. 1.

Referring to FIG. 2, a controller unit 21 is connected to an operating section 25, a scanner 37 as an image input device that inputs image data obtained by reading an image on an original, and a printer 38 as an image output device which prints an image based on the input image data. Further, the controller unit 21 is connected to the network 4 and the public telephone line 5, appearing in FIG. 1.

The controller unit 21 is comprised of the following devices:

A CPU 22 is a controller for controlling the whole image forming apparatus illustrated in FIG. 1. A RAM 23 serves as a system work memory for use in operation of the CPU 22, and an image memory for temporarily storing image data.

An operating section interface 24 is an interface with the operating section 25, and outputs image data the operating section 25 so as to be displayed thereon. Further, the operating section interface 24 has a function of transmitting information input by the user via the operating section 25 to the CPU 22.

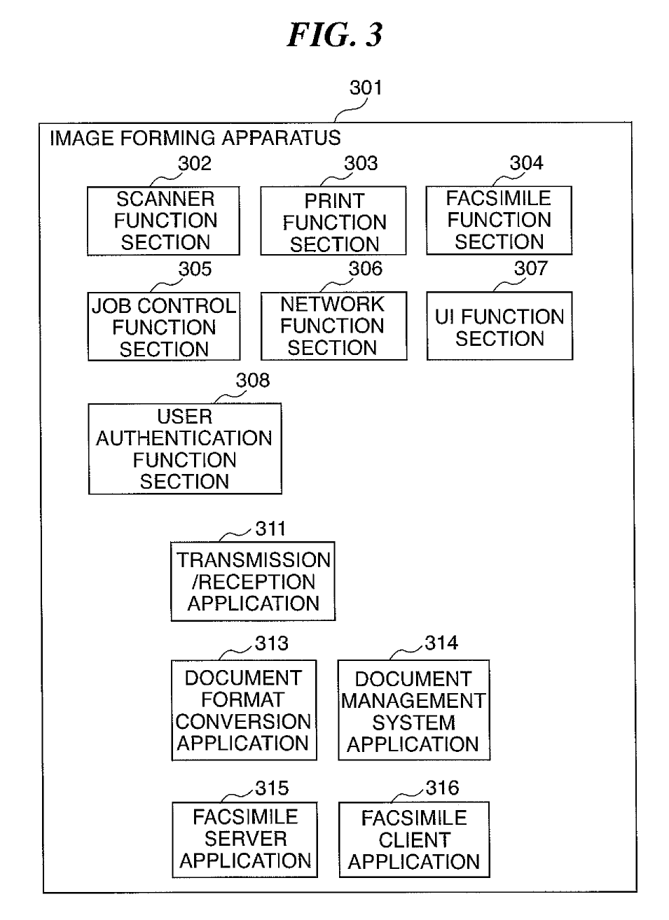

A network interface 26 is connected to the network 4, for sending and receiving information to and from the other image forming apparatuses on the network 4. A modem 27 is connected to the public telephone line 5, and performs modulation/demodulation for sending and receiving information to and from another image forming apparatus on the public telephone line 5. A ROM 28 is a boot ROM, and stores a boot program for the system of the image forming apparatus. An HDD 29 is a hard disk drive, and stores system software, application software, and image data shown in FIG. 3. The above-described devices are arranged on a system bus 39.

An image bus interface 30 is a bus bridge that converts a data structure, and is connected to a system bus 39 and an image bus 40 that transfers image data at high speed. The image bus 40 is implemented by a PCI bus or an IEEE 1394.

Arranged on the image bus 40 are devices, such as an image compressing/expanding section 31, a raster image processor (RIP) 32, a device interface 33, a scanner image processing section 34, a printer image processing section 35, and an image rotation section 36.

The image compressing/expanding section 31 compresses multivalued image data into JPEG (Joint Photographic Expert Group) format data, and binary image data into JBIG (Joint Bi-level Image experts Group), MMR (Modified Modified READ) or MH (Modified Huffman) format data. Inversely, the image compressing/expanding section 31 performs expansion processing on the compressed image data. The RIP 32 develops PDL code into a bitmap image.

The device interface 33 connects between the scanner 37 and the printer 38, and the controller unit 21. The scanner image processing section 34 performs correction, modification, and editing on image data input from the scanner 37.

The printer image processing section 35 performs correction and resolution conversion on image data output to the printer 38. The image rotation section 36 rotates image data. The operating section 25 includes a touch panel provided with a display device, such as an LCD, and is capable of displaying information to be transmitted to the user, and inputting various instructions desired by the user therefrom.

FIG. 3 is a functional block diagram of pieces of software that operate on the controller unit 21 appearing in FIG. 2. These pieces of software are programs which are stored in the HDD 29, and are loaded in the RAM 23 by the CPU 22 for execution, as required.

The image forming apparatus 301 represents each of the image forming apparatuses 1 to 3 appearing in FIG. 1. A scanner function section 302 that uses the scanner 37 has a function of reading an image on an original and converting the read image into binary or multivalued image data.

A print function section 303 has a function of outputting image data obtained by converting an image read by the scanner function section 302, or externally received facsimile data, IFAX data, or print data, to the printer 38, after adding a command for the image data.

A facsimile function section 304 encodes an image read by the scanner function section 302 and converted into image data, according to a facsimile standard, such as G3 (Group 3) or G4 (Group 4). Further, the facsimile function section 304 has a function of transmitting image data to an external facsimile machine using a protocol (e.g. T.30 of the ITU-T) conforming to the facsimile standard. Further, the facsimile function section 304 has a function of receiving a facsimile image transmitted from the external facsimile machines according to the facsimile standard.

A job control function section 305 queues image data received from the scanner function section 302, and image data externally received via the network 4 and the public telephone line 5, as print jobs, transmission jobs, facsimile jobs, and so forth. Then, the job control function section 305 sequentially outputs the jobs to selected ones of the print function section 303 and the facsimile function section 304, and a network function section 306, a facsimile server section 315, and a facsimile client section 316, referred to hereinafter, as required.

The network function section 306 has a function of performing transmission by various network protocols, such as TCP/IP (Transmission Control Protocol/Internet Protocol), HTTP (Hypertext Transfer Protocol), FTP (File Transfer Protocol), LDAP (Lightweight Directory Access Protocol), SNMP (Simple Network Management Protocol), SMTP (Simple Mail Transfer Protocol), POP3 (Post Office Protocol—Version 3), and SSL (Secure Socket Layer) protocol.

A user interface function section (UI function section) 307 manages information input by the user via the operating section 25 of the image forming apparatus 301, and information displayed on the operating section 25. In addition, the UI function section 307 displays input fields, output message fields, and so forth, on the operating section 25, and receives values input by the user to the input fields, to notify the values to the other function sections associated with the values. Further, the UI function section 307 has a function of displaying messages from the other function sections to the user, on the operating section 25. The UI function section 307 is also capable of converting information to be displayed on the operating section 25 into an HTML, XML or like other format, and transmitting the converted information to a device on the network 4, for causing the information to be displayed by a web browser. The UI function section 307 is capable of then receiving instructions via the displayed web browser, and causing processing based on the instructions to be executed similarly to the processing executed via the operation of the operating section 25.

A user authentication function section 308 performs user authentication for the image forming apparatus 301. The user authentication function section 308 has a function of authenticating a user who use functions of the image forming apparatus, using user authentication information received from the user.

The authentication information (information for identifying a user, a password, and so forth) from the user can be received e.g. via the UI function section 307 or from a device (not shown) on the network. The user authentication information used by the user authentication function section 308 includes user authentication information stored in advance e.g. in a user authentication server (not shown) on the network and the RAM 23 of the image forming apparatus. Further, the user authentication information may be directly input from the operating section 25 or may be input after acquiring the same from an IC card storing the user authentication information.

The user authentication function section 308 further has a function of displaying a list of users acquired by querying the user authentication server on the network, or a list of users stored in the RAM 23 of the image forming apparatus 301. Further, the user authentication function section 308 has a function of enabling a user to be specified from the list of the users and performing user authentication in response to input of a password or a like associated with the user. If correct user information and password are input to make the user authentication successful, the user authentication function section 308 notifies the devices on the network 4 of login information indicating that the user has logged in. The devices having received the notification are capable of recognizing which device the user is currently operating.

A transmission/reception application 311 has a function of receiving an E-mail transmitted from a device on the network 4 using the network function section 306 by SMTP or POP3. Further, the transmission/reception application 311 has a function of causing a received E-mail or image data which is attached to a received E-mail and is compliant with the IFAX standard to be printed by the print function section 303. As the IFAX standard, it is possible to use e.g. one compliant with the recommendation T.37 of the ITU-T.

Further, the transmission/reception application 311 attaches image data acquired from the scanner function section 302 to an E-mail as a file, and transmits the image data to a specified transmission destination by SMTP. Further, the transmission/reception application 311 has a function of storing the acquired image data as a file in a file server by FTP (File Transfer Protocol), SMB (Server Message Block), or the like.

A document format conversion application 313 has a function of converting image data acquired by the scanner function section 302 into one of various file formats according to specification from the operating section 25.

Similarly, the document format conversion application 313 has a function of converting image data received using the network function section 306 into a specified file format.

A document management system application 314 manages the following image data: image data acquired from the scanner function section 302, and image data transmitted from devices on the network 4 or via the public telephone line 5, and received using the network function section 306 or the facsimile function section 304.

The document management system application 314 has a function of storing the above-mentioned image data in a document storage location set in advance on the network or in the HDD 29 of the image forming apparatus. It should be noted that the document storage location is divided into areas on a user-by-user basis and is also used when a document transferred to a user is stored by a facsimile server function, as described hereinafter.

A facsimile server application 315 operates in cooperation with the facsimile client application 316 that operates in the image forming apparatus 1, 2 or the like.

More specifically, the facsimile server application 315 accepts a transmission request from a facsimile client via the network 4 and performs transmission using the facsimile function section 304 via the public telephone line 5. Further, the facsimile server application 315 has a function of transferring facsimile data received by the facsimile function section 304 via the public telephone line 5, to a client device via the network 4.

Further, the facsimile server application 315 has the same IFAX function as that of the facsimile server, for performing transmission and reception of data via the network 4 in place of via the public telephone line 5. More specifically, the facsimile server application 315 accepts an IFAX transmission request from a client device via the network 4, and transmits the IFAX transmission request using the transmission/reception application 311 via the network 4.

Alternatively, the facsimile server application 315 has a function of transferring IFAX data received via the network 4 to an appropriate client device. Details of the operation of the facsimile server application 315 will be described hereinafter.

A facsimile client application 316 operates in cooperation with the facsimile server application 315 that operates e.g. in the image forming apparatus 3.

More specifically, the facsimile client application 316 accepts a transmission request from a user via the operating section 25, and transfers image data to a facsimile server (facsimile server application 315) operating in the image forming apparatus 3 in cooperation therewith, to thereby realize facsimile transmission. Further, the facsimile client application 316 performs reception processing for receiving image data received by the facsimile server operating in the image forming apparatus 3 in cooperation therewith. Details of the operation of the facsimile client application 316 will be described hereinafter.

Next, a description will be given of the transfer function of the facsimile server application 315.

The facsimile server application 315 has a transfer processing function for transferring data received by facsimile or IFAX to the image forming apparatus 1, 2 which has a facsimile client function.

A transfer process is carried out based on a transfer settings table which the facsimile server application 315 is equipped with. The transfer settings table is comprised of a plurality of transfer conditions. The transfer conditions are created and edited by displaying a transfer condition-setting screen on the operating section 25 using the UI function section 307, and accepting input to the transfer condition-setting screen from a user.

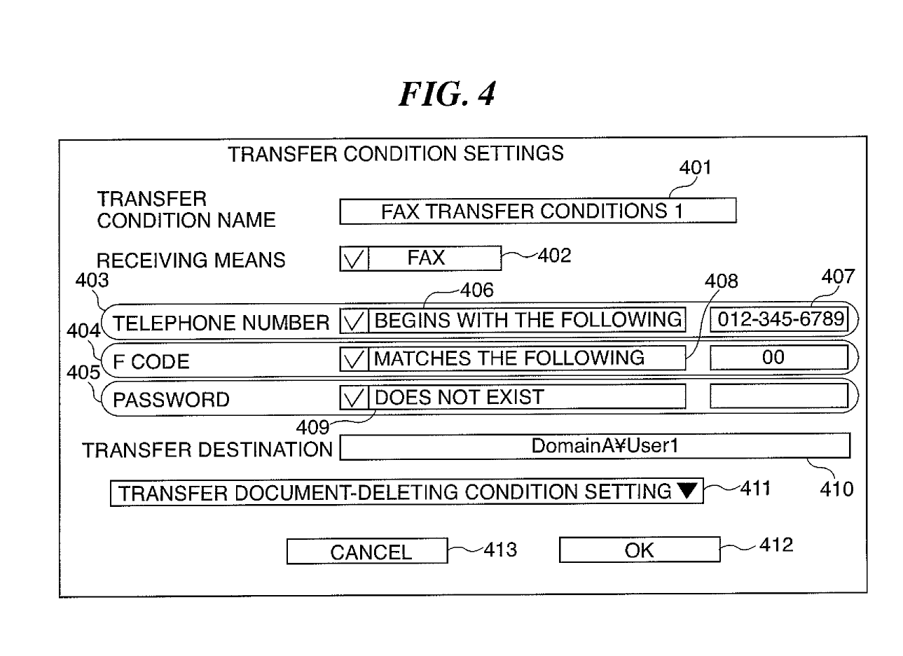

FIG. 4 is a view showing an example of the transfer condition-setting screen displayed on the operating section 25 using the UI function section appearing in FIG. 3. This setting screen can be displayed not only on the operating section 25 but also by a web browser of a device on the network 4, for enabling user operation thereon.

Referring to FIG. 4, when a transfer condition name 401 is depressed, a soft keyboard screen (not shown) is displayed. The user can input the name of a transfer condition using a soft keyboard of the displayed screen.

When a receiving means-setting pull-down menu button 402 is depressed, a menu of options including FAX and IFAX as receiving means are displayed. The user can select FAX or IFAX from the displayed menu. It should be noted that when the user changes the selected receiving means, the screen display is switched in accordance with the change such that the transfer conditions can be set according to the newly selected receiving means.

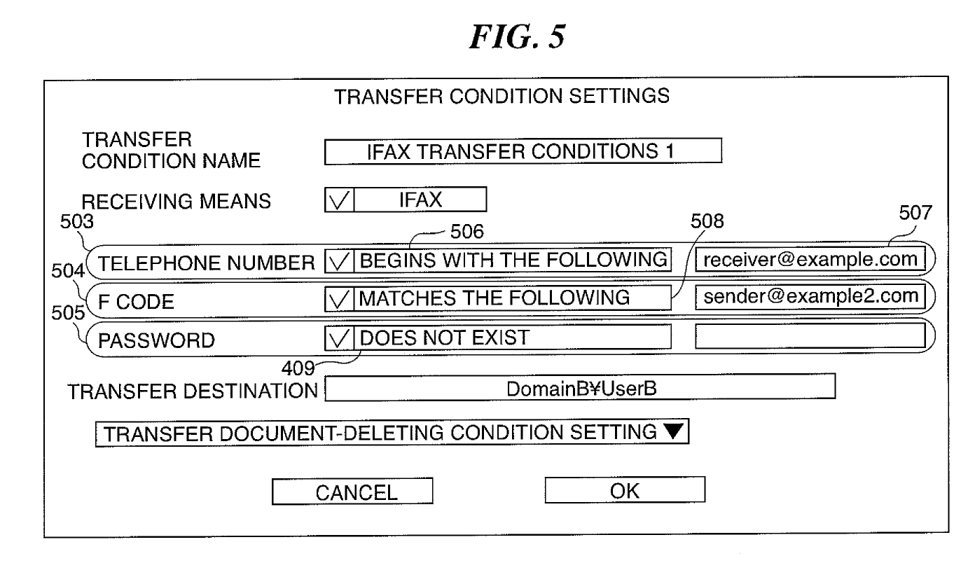

FIG. 4 shows an example of the transfer condition-setting screen displayed when FAX is selected as the receiving means. The user can set the transfer conditions using the conditions of a “telephone number”, an “F code”, and a “password”, which are information items received by procedure signals (TSI (Transmitting Subscriber Identification) and DIS (Digital Identification Signal) signals in T.30) used in the facsimile communication, before reception of image data. When the receiving means is switched to the IFAX, the display on the setting screen is switched, as shown in FIG. 5. This makes it possible for the user to set the transfer conditions using the conditions of a “destination”, a “sender” and a “subject name”, which are information items described in a header section of a received E-mail.

Areas 403, 404, and 405 are provided for setting the conditions of the “telephone number”, the “F code”, and the “password”, respectively. A menu of selection candidates including “disregarded”, “matches the following”, “does not match the following”, “begins with the following”, “ends with the following”, “includes the following”, and “does not include the following” is displayed by depressing a pull-down menu button 406 for enabling the user to select any of the selection candidates.

When a telephone number input field 407 is depressed, a soft keyboard screen (not shown) is displayed. The user can input a telephone number using a displayed soft keyboard.

A selection candidate selected after depressing the pull-down menu button 406 and the telephone number input to the field 407 are combined, thereby making it possible to set various conditions concerning the telephone number. Similarly, a menu of “matches the following” and “does not exist” as selection candidates is displayed by depressing pull-down menu buttons 408 and 409. The user can set the transfer conditions by respective combinations of these selections and entries.

It should be noted that when the conditions concerning the “telephone number”, the “F code”, and the “password” are all satisfied, the transfer conditions for performing the transfer process are set. Further, conditions for use in setting the transfer conditions are not limited to the above-mentioned information items, but any other information item may be used insofar as it can be used in the facsimile communication and is received together with image data or contained in image data. More specifically, the information item may be original information of a manufacture contained in an NSF (Non-standard facilities) signal or information contained in image data. Further, it may be information sent from a telephone switchboard other than information sent from a sender device.

When an area 410 for setting a transfer destination is depressed, a transfer destination-setting screen, described hereinafter, is displayed. As a transfer destination, it is possible to set a device or an address of the transfer destination from a destination table included in the image forming apparatus 301, or specify the user included in information used in the above-described user authentication. In the example of the transfer condition-setting screen shown in FIG. 4, a user called User 1 of Domain A is set as a transfer destination. It is assumed that in the present system, a plurality of domains are distinguished from each other for control of users on a domain-by-domain basis.

When a deleting condition-setting button 411 for setting a condition for deleting a transfer document is depressed, a document deleting condition-setting screen, described hereinafter, is displayed. When an OK button 412 is depressed, the transfer conditions are added to the transfer settings table. When a cancel button 413 is depressed, the present screen is closed without adding the input transfer conditions to the transfer settings table.

FIG. 5 is a view showing an example of the transfer condition-setting screen, displayed when IFAX is selected as the receiving means by depressing the receiving means-setting pull-down menu button appearing in FIG. 4.

The transfer condition-setting screen illustrated in FIG. 5 has the same configuration as that of the setting screen illustrated in FIG. 4, except that in the FIG. 5, the areas 403, 404, and 405 in FIG. 4 for setting the conditions of the “telephone number”, the “F code”, and the “password” are replaced by areas 503 to 505 for setting the conditions of the “destination”, the “sender” and the “subject name”. The “destination”, the “sender”, and the “subject name” are respective information items set forth in a To field, a From field, and a Subject field of a header section of a received E-mail. However, the information items for use in the transfer conditions are not limited to these. More specifically, information for use in the transfer conditions may be any information item insofar as it is transmitted together with data of a transferred object, or is contained in data of the transferred object. For example, it is possible to use information that is contained in the header section but other than the above-mentioned information, information contained in the body of the received E-mail, information contained in image data attached to the E-mail, and information that is received from a sender device, an SMTP (Simple Mail Transfer Protocol) server, or a POP3 server, separately from the E-mail when the E-mail is received.

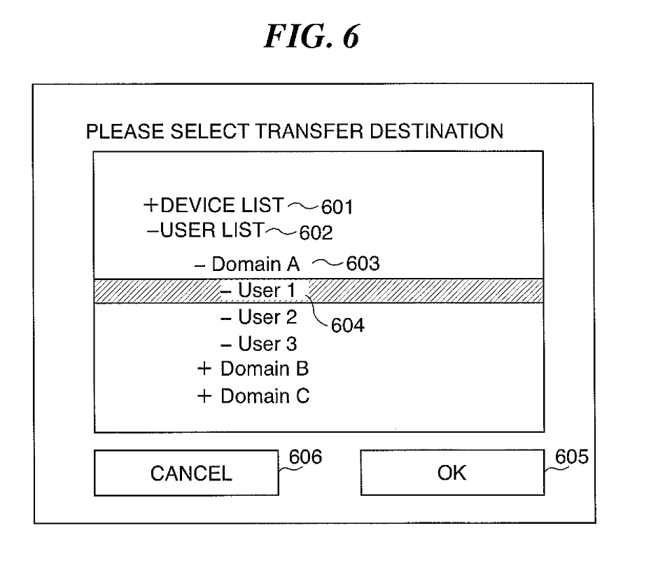

FIG. 6 is a view showing an example of a transfer destination-setting screen displayed when the area 410 in FIG. 4 is depressed.

In FIG. 6, areas 601 and 602 are for unfolding a device list and a user list, respectively. When selected by the user, the areas 601 and 602 display lists of devices and users, which can be set as transfer destinations.

FIG. 6 shows a case where the user list is selected. When the user list is selected, a list of domains is displayed. Further, when a domain is selected from the domain list, a list of users of the domain is displayed. The user of the image forming apparatus 301 can set a transfer destination by selecting one of the users from the user list and depressing an OK button 605. Further, the user of the image forming apparatus 301 can cancel the setting by a cancel button 606.

The example illustrated in FIG. 6 shows that User 1 (area 604) of Domain A is selected as a transfer destination. It should be noted that the user list displayed in the illustrated example can be acquired by querying the user authentication function section 308.

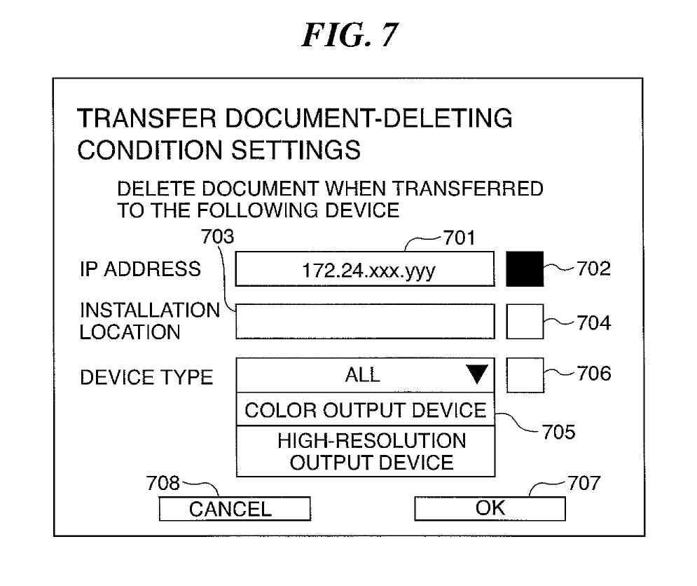

FIG. 7 is a view showing an example of the transfer document deleting condition-setting screen displayed when the deleting condition-setting button appearing in FIG. 4 is depressed.

By inputting conditions from this screen, the user can set whether to delete or not to delete but store transfer data after transferring the same according to the transfer settings, depending on transfer conditions.

When an IP address-setting box 701 is depressed, a screen (not shown) for use in inputting an IP address is displayed. A validation button 702 is depressed when a condition described in the IP address-setting box 701 is to be validated. The validation button 702 is a toggle and hence the condition is invalidated when the validation button 702 is depressed again. If the user desires to delete a document only when the document is transferred and output to a specific device, the user can specify the specific device by the IP address. It should be noted that although in the illustrated example, the IP address is used as information for identifying the device, other suitable information, such as the name of the device, may be used insofar as the device can be identified by the information.

When an installation location input box 703 is depressed, an installation location input screen (not shown) is displayed. An installation location where a device is installed is set by selecting the installation location from a list of installation locations registered in advance. A validation button 704 is used for validating and invalidating the condition set forth in the installation location input box 703. If the user desires to delete a document only when the document is transferred and output to a device installed in a specific location (e.g. a floor that the user normally uses), the user can specify the specific location by the installation location. Further, it may be configured to identify devices within a specific range by using part of the IP address.

When a device type-setting box 705 for setting a device type is depressed, a pull-down menu of options including “all”, “color output device”, and “high-resolution output device” is displayed. A validation button 706 is used for validating and invalidating the condition set forth in the device type-setting box 705. If the user desires to delete a document only when the document is transferred and output to a device having a specified characteristic (e.g. a device capable of color output), the user can specify the device by the device type. Further, as the device type, there may be employed information e.g. indicative of whether the device is an image forming apparatus or a personal computer.

When an OK button 707 is depressed, the input deleting conditions are set as transfer conditions, followed by returning to the screen appearing in FIG. 4 or 5. The above-described configuration of the settings can be canceled by depressing a cancel button 708.

It should be noted that although in the illustrated examples, the deleting conditions are set by an IP address, an installation location, and a device type, the document deleting condition-setting screen may be configured such that the document deleting conditions can be set by other device information (a specific model, a version of the system, etc.) if purposes of setting the IP address, the installation location, and the device type can be attained. The purposes are identification of a device, identification of a location where the device is installed, and identification of a function of the device. Of course, document deleting conditions may be set for purposes other than the above.

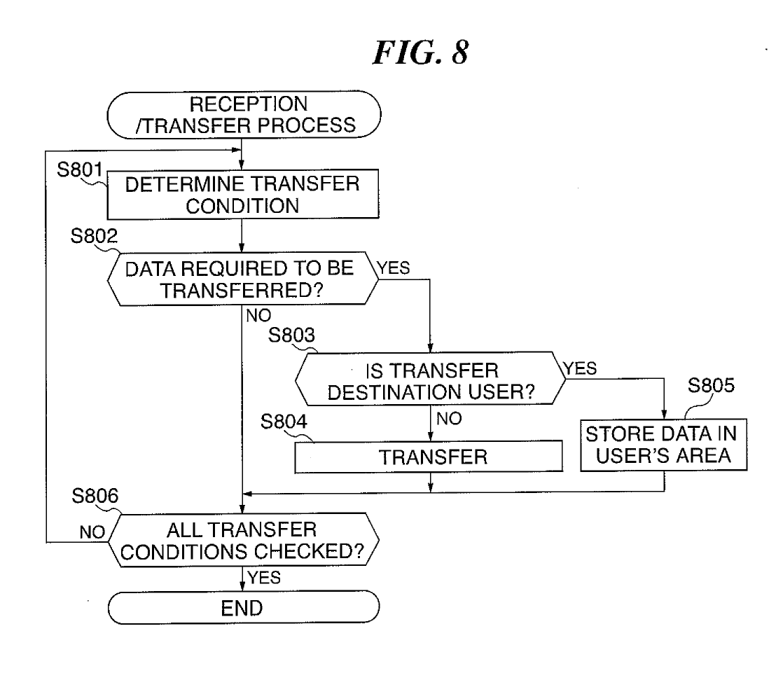

FIG. 8 is a flowchart of a reception/transfer process executed by the facsimile server application appearing in FIG. 3, when the image forming apparatus operates as a server apparatus. This process is executed by the CPU 22 which loads a program therefor in the RAM 23 and executes the program.

The process is started upon reception of FAX data or IFAX data. Now, let it be assumed that information items (information items shown in the areas 403 to 405 in FIG. 4, and the areas 503 to 505 in FIG. 5) for use in configuring transfer conditions are stored in the RAM 23 when the FAX data or the IFAX data is received. First, transfer conditions are determined (step S801). If the received data is FAX data, the information items, such as the “telephone number”, the “F code”, and the “password” of the received FAX data are acquired from the RAM 23, and it is determined whether or not the information items satisfy the transfer conditions registered in the transfer setting table (step S802). If the received data is IFAX data, the information items, such as the “destination”, the “sender”, and the “subject name” of the received IFAX data are acquired from the RAM 23, and it is determined whether or not the information items satisfy the transfer conditions (step S802).

If it is determined in the step S802, that the received data is not required to be transferred, i.e. if the received data does not satisfy the transfer conditions, the process proceeds to a step S806, whereas if it is determined that the received data is required to be transferred, the process proceeds to a step S803.

In the step S803, it is determined whether or not the transfer destination specified by the transfer settings is a user. If the transfer destination is not a user, the process proceeds to a step S804, wherein the received data, i.e. transfer data is transferred to a designated transfer destination. It should be noted that before transferring the transfer data, the document format conversion application 313 is requested to convert the transfer data into a proper format (e.g. converting the transfer data into a TIFF (Tagged Image File Format) formatted file according to the IFAX standard if the transfer destination is an IFAX address), and after the conversion, the transfer data is transferred.

If it is determined that the transfer destination is a user, the process proceeds to a step S805, wherein the received data is stored in an area of the HDD 29, associated with the user as the transfer destination, by using the function of the document management system application 314.

In the step S806, it is determined whether or not all the transfer conditions have been checked for determination. If there is any transfer condition remaining unchecked, the process returns to the step S801, wherein the next transfer condition is checked for determination. When all the transfer conditions have been checked up, the present process is terminated.

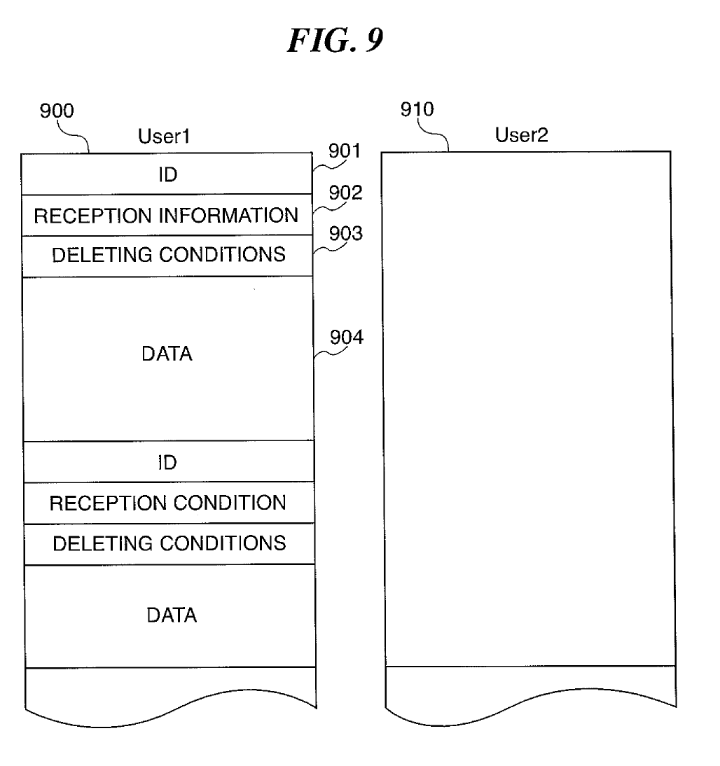

FIG. 9 is a schematic view of data stored in a manner associated with the user in the step S805 in FIG. 8.

In FIG. 9, an area 900 is associated with User 1, and an area 910 is associated with User 2. In a data area associated with a single transfer data item to be sent to the User 1, ranging from a section 901 to a section 904, the section 901 stores an identifier (ID) 901 which is uniquely determined in association with the transfer data item when it is subjected to storage processing. A section 902 stores reception information comprised of information on a time point at which the data was received, and sender's information, such as a telephone number of a sender of the data. A section 903 stores information on deleting conditions specified in the transfer conditions. The area 904 stores the transfer data item (image data received by facsimile, image data contained in an E-mail received by IFAX, data of a main body of the received E-mail, or the like). Hereafter, each transfer data item to be transferred to User 1 and information items associated therewith are stored in the same format, i.e. in respective associated areas. Similarly, transfer data items to be transferred to User 2 and information items associated therewith are stored in the area 910 associated with User 2.

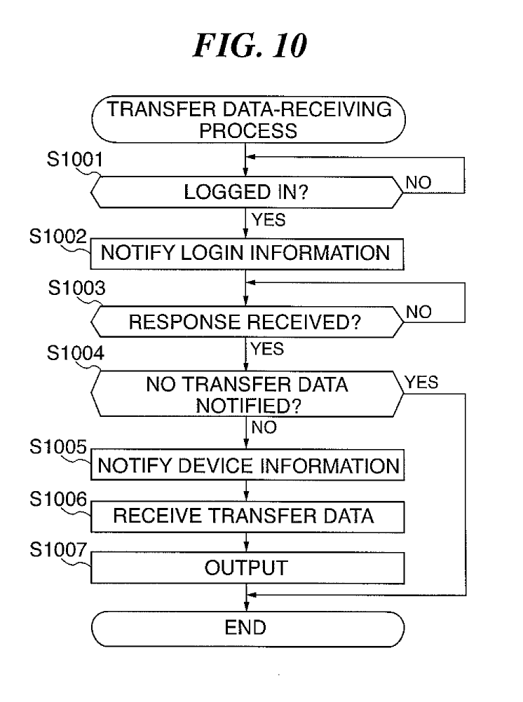

FIG. 10 is a flowchart of a transfer data-receiving process executed by the facsimile client application appearing in FIG. 3 when the image forming apparatus 1 operates as a client apparatus. This process is executed by the CPU 22 which loads a program therefor in the RAM 23 and executes the program.

After starting the process, a login operation by the user is awaited. In a step S1001, it is determined whether or not the login operation has been performed. If the login operation has been performed, the process proceeds to a step S1002 in which the image forming apparatus 1 shows a screen for use in user authentication by using the UI function section 307, and acquires a user name and a password of the user, input by the user, from the operating section 25. The image forming apparatus may be configured such that they receive equivalent user information from an IC card in place of the user information input via the operating section 25.

Then, the user authentication function section 308 acquires the received user information, and performs authentication processing. When the authentication processing is successful, it is determined that the user has logged in.

In a step S1002, login information (login notification) including the information on (user name of) the user having logged in in the step S1001 is notified to the facsimile server application 315 of the image forming apparatus 3 via the network.

In a step S1003, a response from the facsimile server application 315 of the image forming apparatus 3 is awaited. Upon reception of the response, the process proceeds to a step S1004.

In the step S1004, it is determined whether or not the response from the facsimile server application 315 is a notification of “No data transferred”. If the response is a notification of “No transfer data”, the transfer data-receiving process is terminated. If it is judged in the step S1004 that the response from the facsimile server application 315 is a notification of “Data transferred”, the process proceeds to a step S1005.

In the step S1005, device information of the image forming apparatus 1 in which the facsimile client application 316 is operating is notified to the facsimile server application 315.

The notified device information is used for determining whether or not the facsimile server application 315 should delete the transfer data. The device information includes the IP address, installation location, capability of color output, and output resolution of the image forming apparatus in which the facsimile client application 316 is operating, as shown in FIG. 7. The notified device information is possessed by the image forming apparatus or set in advance by the user.

After the device information is notified in the step S1005, the transfer data is received from the facsimile server application 315 in a step S1006. In a step S1007, the received data is printed out, followed by terminating the present process.

It should be noted that in the step S1007, it may be configured not to print out the transferred data immediately but to print out the same after causing the UI function section 307 to display the data on the operating section 25 for preview and receiving an instruction from the user.

Further, the transferred data may be stored using the function of the document management system application 314 of the image forming apparatus 301. Furthermore, the transferred data may be further transmitted to another device using the function of the transmission/reception application 311.

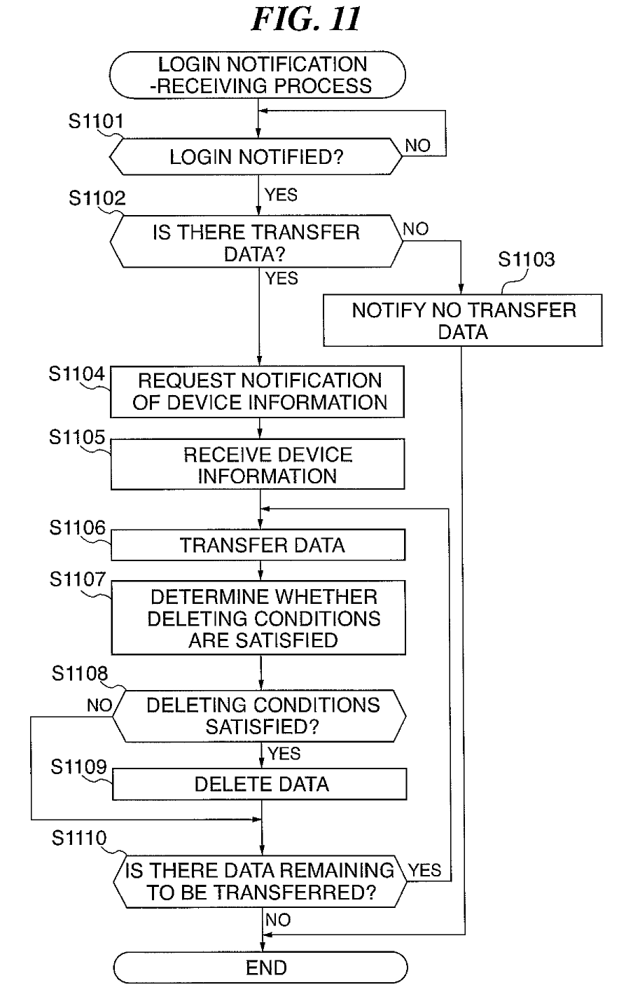

FIG. 11 is a flowchart of a login notification-receiving process performed when the image forming apparatus operates as a server apparatus, and the facsimile server application appearing in FIG. 3 receives a login notification from the facsimile client application appearing in FIG. 3. This process is executed by the CPU 22 which loads a program therefor in the RAM 23 and executes the program.

Referring to FIG. 11, first, in a step S1101, reception of login information which is sent from the facsimile client application 316 via the network is awaited. When the login information is received from the facsimile client application 316, the process proceeds to a step S1102.

In the step S1102, it is determined whether or not transfer data associated with a user name contained in the notified login information is stored. In other words, it is determined whether or not there is data which has been stored in an area associated with the user by executing the process in the step S805 in FIG. 8. More specifically, it is determined whether or not there exists data stored in the area of the user, as shown in FIG. 9. If no transfer data to be transferred to the user is stored, the process proceeds to a step S1103.

In the step S1103, the facsimile client application 316 of the apparatus having transmitted the login information is notified that there is no transfer data to be transferred to the user. If there is transfer data stored in association with the user name contained in the notified login information, the process proceeds to a step S1104.

In the step S1104, the image forming apparatus having notified the login information is requested to send device information thereon. In a step S1105, the device information is received as a response to the request transmitted in the step S1104, and then the process proceeds to a step S1106.

In the step S1106, the transfer data is transferred to the user. It should be noted that before transferring the transfer data, the document format conversion application 313 is requested to convert the transfer data into an appropriate format, so as to transfer the converted transfer data. In the step S1106, there may be employed any type of suitable transfer protocol insofar as it can transfer image data over the network 4. For example, there may be used a protocol determined in advance, or a protocol determined by negotiation between the server apparatus and the client apparatus. After termination of the transfer process, the process proceeds to a step S1107.

In the step S1107, determination as to whether deleting conditions are satisfied is executed. This determination is performed by comparing the device information acquired in the step S1105 with the deleting conditions (stored in the area 903 appearing in FIG. 9) stored together with the transferred data.

It should be noted that as to a deleting condition of “to be deleted if the device type is a color output device”, it is also determined whether or not received data is color data. More specifically, if the received data is color data but the image forming apparatus as a transfer destination is not a color output device, the received data is not to be deleted, whereas if the received data is monochromatic data, the source data is deleted even if the image forming apparatus of a transfer destination is not a color output device.

In a step S1108, if the deleting conditions are not satisfied, the process proceeds to a step S1110. If the deleting conditions are satisfied, the process proceeds to a step S1109.

In the step S1109, the transferred data is deleted. In a step S1110, it is determined whether or not there is any data remaining to be transferred. If there is data remaining to be transferred, the process returns to the step S1106. When all the data items to be transferred to the user are transferred by repeatedly carrying out the steps S1106 to S1110, the present process is terminated.

It should be noted that data which has not satisfied the deleting conditions remains stored in the area associated with the user even after termination of the transfer process. In the step S1102, if such data (data subjected to the transfer process but not deleted) is contained in the transfer data associated with the notified user, the facsimile client application 316 may be notified of the fact.

In this case, the facsimile client application 316 having received the notification may display a message to the above effect via the operating section 25, so as to cause the user to select whether or not to print out the data.

Further, when such data exists, the facsimile server application 315 may transmit an E-mail to a mail address registered in advance, for notification of the fact. In this case, the mail may be caused to contain an URL for use in referring to, deleting, or printing out the data. By referring to the URL later, the user can instruct the display, deletion, printout or the like of data remaining in the facsimile server application 315.

As described heretofore, according to the present embodiment, it is possible set a user as a transfer destination as one of transfer conditions which the facsimile server application 315 checks for determination as to whether to transfer data, and when the facsimile server application 315 receives a login notification from the facsimile client application 316, the facsimile server application 315 transfers transfer data to the user.

As a consequence, to whichever image forming apparatus the user logs in during operation of the facsimile client application 316 in the image forming apparatus, the user can receive transfer data transmitted to the user by the image forming apparatus. Further, it is possible to cause only received data to be transferred which satisfies transfer conditions stored in the server apparatus in advance, and hence it is possible to cause only data satisfying desired transfer conditions to be selectively transferred. This enables the user to receive desired transfer data easily at an image forming apparatus to which the user has logged in. Further, it is possible to set whether or not to delete the transferred source data after executing the transfer, depending on conditions of the image forming apparatus as a transfer destination. This makes it possible to receive transfer data once by the image forming apparatus, and afterwards acquire the transfer data again by another image forming apparatus. Further, it is possible to eliminate the inconvenience that unnecessary data continues to be stored.

By the way, according to the system of the present embodiment, although there is a possibility that transfer data is transferred to various image forming apparatuses, in many cases, whether or not to delete transferred source data after the transfer depends on which image forming apparatus the user has transferred transfer data to. For example, there can arise the following demands:

Although source data is desired to be deleted when it is transferred to an image forming apparatus capable of color output, the source data is desired to be left as it is when transferred to an image forming apparatus incapable of color output.

Although source data is desired to be deleted when it is transferred to an image forming apparatus located in a usual office, the source data is desired to be left as it is when transferred to an image forming apparatus at a destination of a business trip.

According to the present embodiment, after transferring transfer data, it is possible to set whether or not to delete the transfer source data, depending on conditions of an image forming apparatus as a transfer destination, which makes it possible to easily meet the above-described demands.

It should be noted that although in the above-described embodiment, the description has been given of the image forming apparatuses, by way of example, this is not limitative, but an apparatus to which the user logs in and server apparatuses are not necessarily image forming apparatuses, but they are each only required to have data communication functions as those of personal computers.

Further, although data items are received by facsimile and IFAX, by way of example, this is not limitative, but they may be received by other protocols.

However, the component elements described in the above embodiment are only described by way of example, and are by no means intended to limit the scope of the present invention to them alone.

It should be noted that the present invention may be applied to a system comprised of a plurality of devices and apparatuses, or may be applied to an apparatus formed by a single piece of equipment. For example, the present invention may be applied to a computer system comprised of a printer, a facsimile machine, personal computers, servers, and clients.

It is to be understood that the present invention may also be accomplished by supplying a system or an apparatus with a storage medium in which a program code of software, which realizes the functions of the above described embodiment, is stored, and causing a computer (or CPU or MPU) of the system or apparatus to read out and execute the program code stored in the storage medium.

In this case, the program code itself read from the storage medium realizes the functions of the above described embodiment, and therefore the program code and the storage medium in which the program code is stored constitute the present invention.

The form of the above program code may be an object code, a program executed by an interpreter, script data supplied to an OS (Operating System), or the like.

Examples of the storage medium for supplying the program code include a floppy (registered trademark) disk, a hard disk, a magnetic-optical disk, an optical disk, such as a CD-ROM, a CD-R, a CD-RW, a DVD-ROM, a DVD-RAM, a DVD-RW, or a DVD+RW, a magnetic tape, a nonvolatile memory card, and a ROM. Alternatively, the program may be downloaded via a network.

Further, the program may be downloaded from a home page on the Internet using a browser of a client computer. More specifically, the computer program itself according to the present invention, or a file compressed and containing an automatic install function may be downloaded from the home page to a recording medium, such as a hard disk. Further, the program of the present invention can be realized by dividing the program code constituting the program into a plurality of files and downloading the respective files from different home pages. In short, a WWW server as well, which is provided for downloading program files for realizing the functions and processes according to the present invention, to a plurality of users, sometimes serves as an essential component of the present invention.

Further, the program of the present invention may be encrypted and stored in storage media, such as CD-ROMs, such that it is distributed to users. In this case, only users that have satisfied predetermined conditions may be caused to download key information for releasing the encryption, from the home page via the Internet, to decrypt and execute the encrypted program using the key information, to thereby install the program on a computer of the user.

Further, it is to be understood that the functions of the above described embodiment may be accomplished not only by executing the program code read out by a computer, but also by causing an OS (operating system) or the like which operates on the computer to perform a part or all of the actual operations based on instructions of the program code.

Further, it is to be understood that the functions of the above described embodiment may be accomplished by writing a program code read out from the storage medium into a memory provided on an expansion board inserted into a computer or a memory provided in an expansion unit connected to the computer and then causing a CPU or the like provided in the expansion board or the expansion unit to perform a part or all of the actual operations based on instructions of the program code.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures and functions.

This application claims priority from Japanese Patent Application No. 2007-268009 filed Oct. 15, 2007, which is hereby incorporated by reference herein in its entirety.

What is claimed is:

1. A data communication apparatus having a function of transferring data received via a public telephone line or a network to another apparatus, comprising:
a storage unit configured to store transfer condition set based on information contained in the received data or information received together with the received data;
a login notification-receiving unit configured to receive a login notification from the other apparatus;
a determination unit configured to determine whether there is transfer data that satisfies the transfer condition stored in said storage unit and is to be transferred to a user associated with the login notification received by said login notification-receiving unit; and
a transfer unit configured to transfer transfer data to the other apparatus that has transmitted the login notification received by said login notification-receiving unit, when said determination unit determines that there is the transfer data.

2. A data communication apparatus as claimed in claim 1, further comprising:
a deleting condition-determining unit configured to determine whether condition for deleting the transfer data transferred by said transfer unit are satisfied; and
a data-deleting unit configured to delete the transfer data transferred by said transfer unit, when said deleting condition-determining unit determines that the transfer data transferred by said transfer unit satisfies the deleting condition.

3. A data communication apparatus as claimed in claim 2, wherein said deleting condition-determining unit determines whether the condition for deleting the transfer data transferred by said transfer unit are satisfied, based on information for identifying said client apparatus.

4. A data communication apparatus as claimed in claim 2, wherein said deleting condition-determining unit determines whether the conditions for deleting the transfer data transferred by said transfer unit are satisfied, based on a location where the other apparatus is installed.

5. A method of controlling a data communication apparatus having a function of transferring data received via a public telephone line or a network to another apparatus, comprising:
storing transfer conditions set based on information contained in the received data or information received together with the received data;
receiving a login notification from the other apparatus;
determining whether there is transfer data that satisfies the stored transfer conditions and is to be transferred to a user associated with the received login notification; and
transferring transfer data to the other apparatus that has transmitted the received login notification, when it is determined that there is the transfer data.

6. A method as claimed in claim 5, further comprising:
determining whether condition for deleting the transferred data are satisfied; and
deleting the transferred data when it is determined that the transferred data satisfies the deleting conditions.

7. A method as claimed in claim 6, wherein the determining whether the conditions for deleting the transferred data are satisfied is based on information for identifying the other apparatus.

8. A method as claimed in claim 6, wherein the determining whether the conditions for deleting the transferred data are satisfied is based on a location where the other apparatus is installed.

9. A storage medium storing, in a computer-readable manner, a program for causing a computer to execute a method of controlling a data communication apparatus having a function of transferring data received via a public telephone line or a network to another apparatus,
wherein the method comprises:
storing transfer conditions set based on information contained in the received data or information received together with the received data;
receiving a login notification from the other apparatus;
determining whether there is transfer data that satisfies the stored transfer conditions and is to be transferred to a user associated with the received login notification; and
transferring transfer data to the other apparatus that has transmitted the received login notification, when it is determined that there is the transfer data.
